(19) United States
(12) Patent Application Publication
(10) Pub. No.: US 2010/0058007 A1
(43) Pub. Date: Mar. 4, 2010

(54) INFORMATION PROCESSING APPARATUS AND MEMORY MANAGEMENT METHOD

(75) Inventor: Satoshi YAMAUCHI, Tachikawa-shi (JP)

Correspondence Address: PATTERSON & SHERIDAN, L.L.P., 3040 POST OAK BOULEVARD, SUITE 1500, HOUSTON, TX, 77056, US

(73) Assignee: KABUSHIKI KAISHA TOSHIBA, Tokyo (JP)

(21) Appl. No.: 12/480,543

(22) Filed: Jun. 8, 2009

(30) Foreign Application Priority Data
Aug. 26, 2008 (JP) 2008-216826

(51) Int. Cl. G06F 12/00; G06F 1/32; G06F 1/26

(52) U.S. Cl. 711/156; 713/323; 711/E12.001

(57) ABSTRACT

According to one embodiment, an information processing apparatus includes a CPU, a first memory which is a volatile memory and which is assigned a storage area accessible by the CPU, a second memory which is a non-volatile memory and which includes a capacity smaller than the first memory, and a hibernation/resume module. The hibernation/resume module includes an access log recording module which records an access generation order with respect to each storage area in the first memory after a shift to a power-on state, and a memory management module which saves data corresponding to a storage area in which an order in a predetermined range is recorded by the access log recording module in the second memory without compression in a shift to a power-off state, and saves data corresponding to other storage areas to save them to the second memory with compression.

### CROSS-REFERENCE TO RELATED APPLICATIONS

This application is based upon and claims the benefit of priority from Japanese Patent Application No. 2008-216826, filed Aug. 26, 2008, the entire contents of which are incorporated herein by reference.

### BACKGROUND

1. Field

One embodiment of the invention relates to a memory management technique, which is adaptable to an information processing apparatus including a function of restoring a previous work interruption state when power is turned on.

2. Description of the Related Art

Recently, various home electrical appliances include built-in CPU and memory to realize multi-functionality using programs. Most of this kind of home electrical appliances includes a so-called hibernation/resume function. According to the hibernation/resume function, the previous power-off operation state is restored when power is turned on.

The hibernation/resume function has the following advantages. Specifically, the procedures for loading programs to a memory and execution of initialization routine by programs are omitted. Therefore, it is possible to shorten time until an apparatus becomes a usable state after power is turned on. Further, according to the hibernation/resume function, power saving is performed compared with a suspend/resume function of continuing a power supply to a memory during power-off. Various proposals have been made effectively use the foregoing hibernation/resume function (e.g., see Jpn. Pat. Appln KOKAI Publication No. 2001-22464).

In recent years, a non-volatile memory such as a NOR flash memory is used in place of a conventional hard disk as data saved target in the hibernation/resume function. The non-volatile memory executes data access at high speed compared with the hard disk. Therefore, it is possible to shorten time until an apparatus becomes a usable state after power is turned on.

However, the non-volatile memory is expensive. If a non-volatile memory including the same capacity as a main memory is used for a hibernation/resume function, it is not realistic taking the cost into consideration at the current. For this reason, it is desired to provide a mechanism for effectively realizing a hibernation/resume function using a non-volatile memory including a capacity smaller than a main memory.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the configuration of an information processing apparatus according to an embodiment of the invention;

FIG. 2 is an exemplary view to explain an operation principle of an hibernation utility program when an information processing apparatus first shifts to a power-off state by a hibernation/resume function in the information processing apparatus according to the embodiment;

FIG. 3 is an exemplary flowchart showing an operation procedure of the hibernation utility program when an information processing apparatus first shifts to a power-off state by a hibernation/resume function in the information processing apparatus according to the embodiment;

FIG. 4 is an exemplary view to explain an operation principle of the hibernation utility program when an information processing apparatus shifts to a power-on state after the shift to a power-off state by a hibernation/resume function in the information processing apparatus according to the embodiment;

FIG. 5 is an exemplary view to explain an operation principle of the hibernation utility program when an information processing apparatus shifts to a power-off state after the shift to a power-on state by a hibernation/resume function in the information processing apparatus according to the embodiment;

FIG. 6 is an exemplary flowchart showing an operation procedure of the hibernation utility program when an information processing apparatus shifts to a power-on state after the shift to a power-off state by a hibernation/resume function in the information processing apparatus according to the embodiment; and

FIG. 7 is an exemplary flowchart showing an operation procedure of the hibernation utility program when the information processing apparatus shifts to a power-off state after the shift to a power-on state by a hibernation/resume function in the information processing apparatus according to the embodiment.

### DETAILED DESCRIPTION

Various embodiments according to the invention will be described hereinafter with reference to the accompanying drawings. In general, according to one embodiment of the invention, an information processing apparatus includes a CPU, a first memory which is a volatile memory and which is assigned a storage area accessible by the CPU, a second memory which is a non-volatile memory and which includes a capacity smaller than the first memory, and a hibernation/resume module. The hibernation/resume module includes an access log recording module which records an access generation order with respect to each storage area in the first memory after a shift to a power-on state, and a memory management module which saves data corresponding to a storage area in which an order in a predetermined range is recorded by the access log recording module in the second memory without compression in a shift to a power-off state, and saves data corresponding to other storage areas to save them to the second memory with compression.

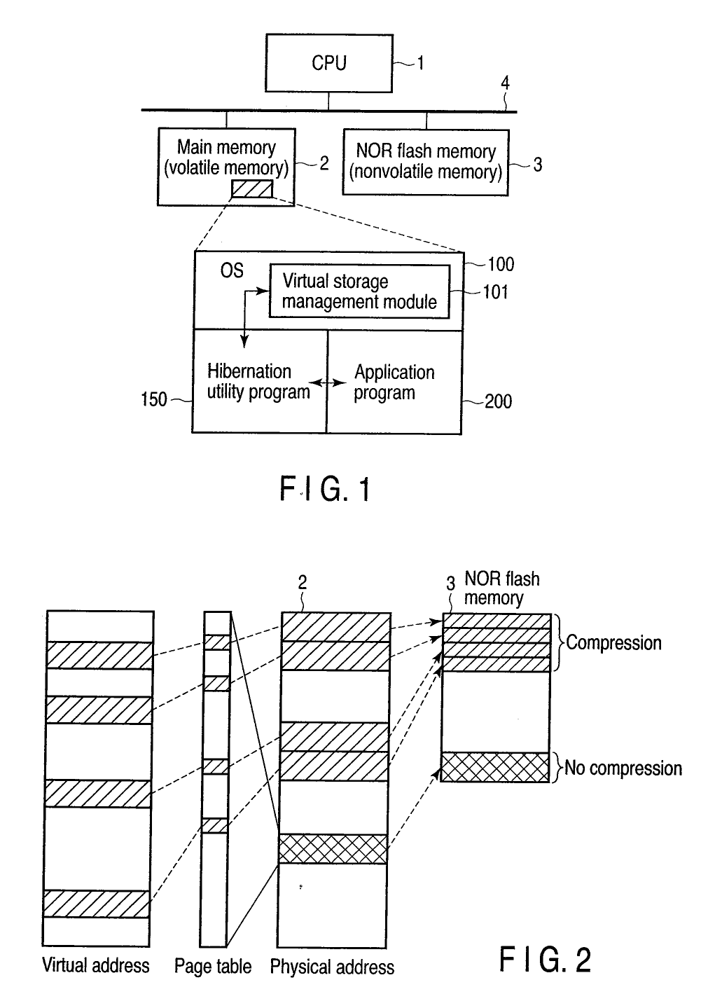

FIG. 1 is an exemplary block diagram showing the configuration of an information processing apparatus according to an embodiment of the invention.

As shown in FIG. 1, the information processing apparatus is formed in such a manner that a CPU 1, a main memory 2 and a NOR flash memory 3 are connected via a system bus 4.

The CPU 1 is a processor for causing the information processing apparatus to perform a predetermined operation by executing various programs loaded in the main memory 2. The main memory 2 is stored with various programs such as an operating system (OS) 100, a hibernation utility program 150 described later and an application program 200 operating under the control of the OS 100, and data used for these programs.

Namely, a memory space accessible by the CPU 1 is assigned to the main memory 2. The correspondence of virtual address on the memory space with an physical address on the main memory is managed by a virtual storage management module 101 of the OS 100.

The NOR flash memory 3 is a linearly accessible (accessible at address unit) non-volatile memory. The information processing apparatus uses the NOR flash memory 3 as a saving area of data (including programs) stored in the main memory 2. The apparatus uses the NOR flash memory 3 to provide a so-called hibernation/resume function of restoring the previous power-off operation state when power is turned on. The hibernation utility program 150 is a program for realizing the foregoing hibernation/resume function. According to this embodiment, the NOR flash memory 3 is used as the data saving area; however, the present invention is not limited to above. For example, the NOR flash memory 3 may be replaceable with an SRAM and an MRAM, which are linearly accessible (accessible at address unit) non-volatile memory.

The information processing apparatus includes the NOR flash memory 3 including a capacity smaller than the main memory 2 taking the cost into consideration.

The information processing apparatus includes a mechanism for effectively realizing the hibernation/resume function using the NOR flash memory 3 including a capacity smaller than the main memory 2. Hereinafter, the mechanism will be described in detail.

Referring now to FIG. 2, the operation principle of the hibernation utility program 150 will be described. In this case, the first shift of the information processing apparatus to a power-off state is performed by the hibernation/resume function. It should be noted that the foregoing first shift means the case that shift to the previous power-off state and shift to a power-on state are made via a normal procedure without using the hibernation/resume function.

In this case, the hibernation utility program 150 compresses all pages including valid data on the main memory 2 to store them in the NOR flash memory 3. Further, the hibernation utility program 150 stores a page table uncompressed in the NOR flash memory 3. The page table holds information indicating the correspondence of virtual address on a memory space (allocated on the main memory 2) and physical address on the main memory 2. Further, the page table holds information (flag) indicating compression/non-compression when data is saved. When the apparatus is shifted to a power-off state by the first hibernation/resume function, information indicating compression is held in all pages. Furthermore, the page table holds information indicating the access order described later. The hibernation utility program 150 manages information indicating a saving target on the NOR flash memory 3 of each page on the main memory 2. In addition, the hibernation utility program 150 manages a location of the main memory 2 of a page included in the page table and a saved location on the NOR flash memory 3.

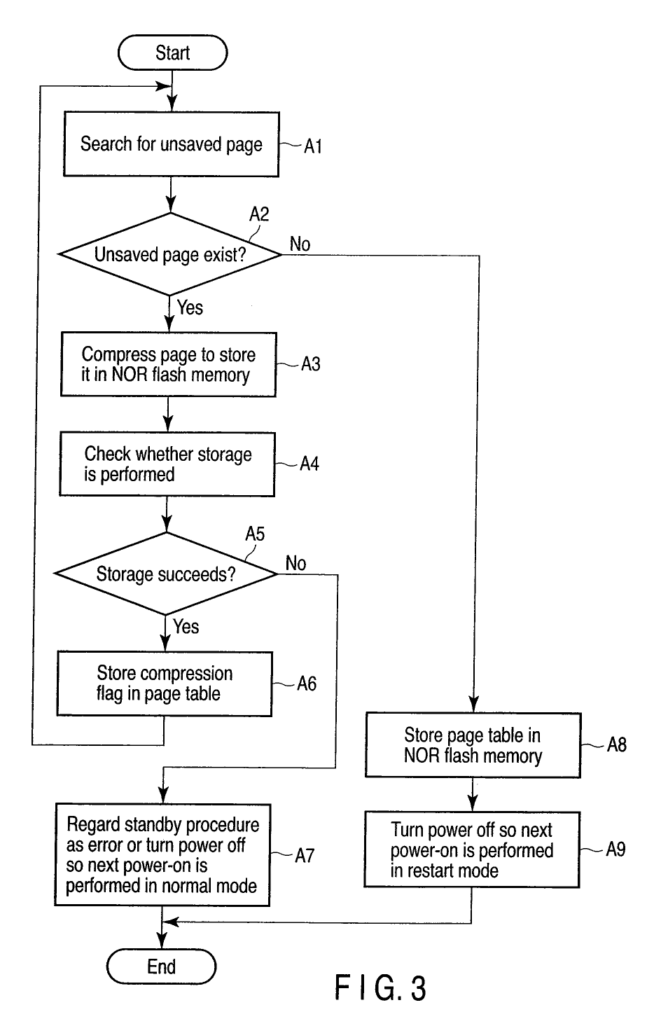

FIG. 3 is an exemplary flowchart showing an operation procedure of the hibernation utility program 150 when the information processing apparatus first shifts to a power-off state by a hibernation/resume function.

The hibernation utility program 150 checks whether or not a page, which includes valid data on the main memory 2 and is not saved in the NOR flash memory 3, exists (block A1). If the page exists (YES in block A2), the hibernation utility program 150 compresses the page to store it in the NOR flash memory 3 (block A3). The hibernation utility program 150 checks whether or not storage to the NOR flash memory 3 normally ends (block A4). If the storage normally ends (YES in block A5), the utility program 150 sets a compression flag of a page table (block A6). Then, the utility program 150 repeats the procedures from block A1.

If the storage to the NOR flash memory 3 does not normally end (block A5), the hibernation utility program 150 takes the following procedure (block A7). Specifically, the utility program 150 ends shift to a power-off state by the hibernation/resume function as an error. Or, the utility program 150 transfers the information processing apparatus to a power-off state so that shift to the next power-on is made via a normal procedure. In block A7, any of the foregoing procedures may be selected according to the specification, and may be set by the user.

Conversely, if a page, which is not saved in the NOR flash memory 3, does not exist, that is, if saving is completed (NO in block A2), the hibernation utility program 150 stores the page table uncompressed in the NOR flash memory 3 (block A8). In this way, the information processing apparatus is shifted to a power-off state so that shift to the next power-on is made by the hibernation/resume function (block A9).

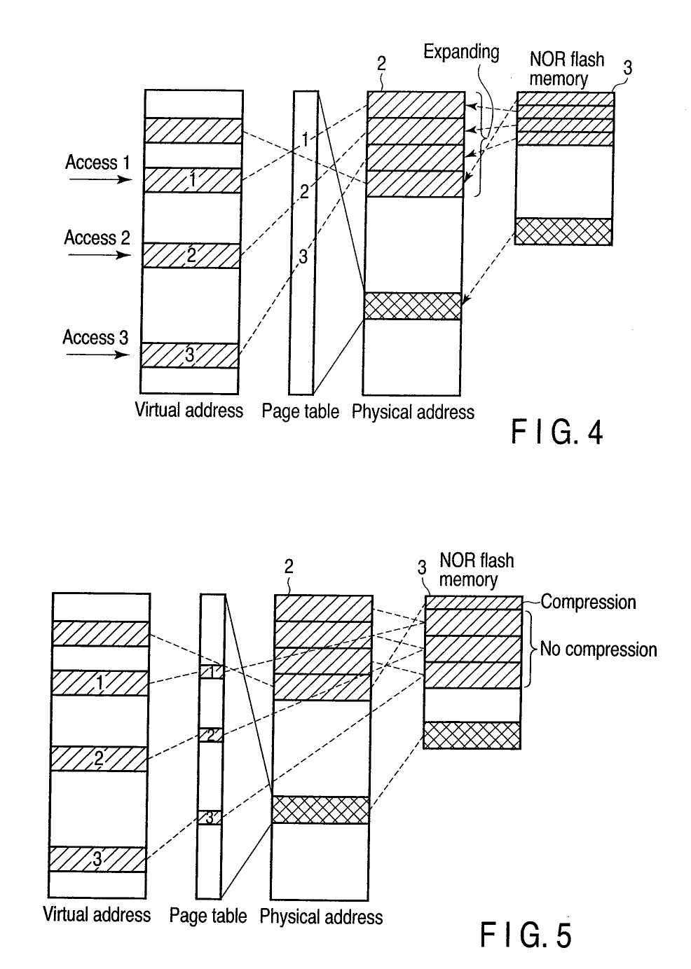

Referring now to FIG. 4, the operation principle of the hibernation utility program 150 will be described. In this case, the information processing apparatus, which is shifted to a power-off state by the hibernation/resume function (i.e., in a state shown in FIG. 2), shifts to a power-on state.

The hibernation utility program 150 reads a page table from the NOR flash memory 3 to restore it on the main memory 2. When the page table is restored, an access request to the main memory 2 is generated according to a virtual address designation. Therefore, the hibernation utility program 150 reads each page from the NOR flash memory 3 according to the access requested order, and then, expands it (because all compression flags are set at that time), and thereafter, restores each page on the main memory 2. Further, the hibernation utility program 150 records the access order in the page table. The hibernation utility program 150 continues the foregoing recording of the access order in the page table until it receives a predetermined notification from the application program 200. The application program 200 transmits the notification to the hibernation utility program 150 when a predetermined application screen output is completed, for example.

Further, the hibernation utility program 150 monitors whether or not the CPU 1 is in an idle state after resume boot. If the CPU 1 is in an idle state, the utility program 150 reads a page, which is not restored on the main memory 2, from the NOR flash memory 3, and then, expands the read page to restore the page on the main memory 2.

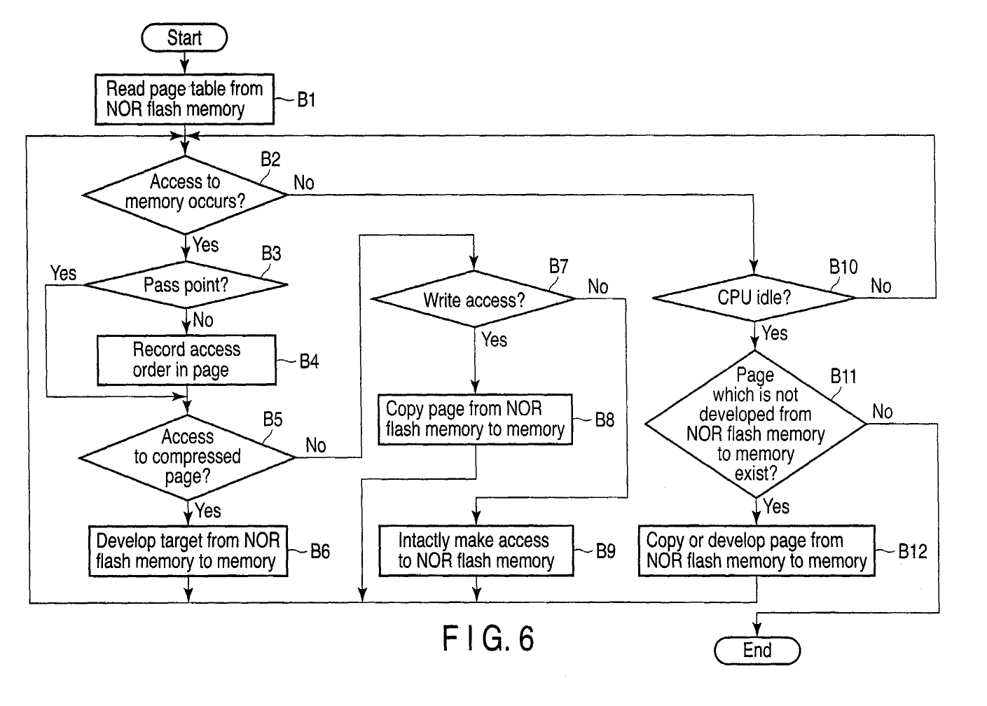

Referring now to FIG. 5, the operation principle of the hibernation utility program 150 will be described. In this case, the information processing apparatus, which is shifted to a power-on state (by the hibernation/resume function) while the access order is recorded in the page table, shifts to a power-off state by the hibernation/resume function after the second time.

In this case, the hibernation utility program 150 searches for a page having no recording of access order in the page table, that is, a page having no access request in a predetermined order when the apparatus shifts to a power-on state. Then, the utility program 150 compresses the pages to store them in the NOR flash memory 3. After the foregoing saved procedure with compression is taken as described above, if the total amount of remaining pages to be saved is less than a free capacity of the NOR flash memory 3, the hibernation utility program 150 stores those pages uncompressed in the NOR flash memory 3.

Conversely, if the total amount of remaining pages to be saved is not less than the free capacity of the NOR flash memory 3, the hibernation utility program 150 executes the following operation. Specifically, the utility program 150 compresses pages one by one in the following order. Namely, the pages are compressed from the last access order, that is, from the late access request order at the time of the shift to a power-on state until the total amount of remaining pages to be saved becomes less than the free capacity of the NOR flash memory 3. If the total amount of remaining pages to be saved becomes less than the free capacity of the NOR flash memory 3, the hibernation utility program 150 stores the remaining all pages uncompressed in the NOR flash memory 3.

The hibernation utility program 150 records compression/non-compression in saving to the NOR flash memory 3 in the page table as a compression flag. Further, the utility program 150 temporarily updates an uncompressed page so that the physical address of the page shows a saved location on the NOR flash memory 3. Finally, the hibernation utility program 150 stores the page table uncompressed in the NOR flash memory 3.

The operation principle of the hibernation utility program 150 will be further described. In this case, the information processing apparatus, which shifts to a power-off state by the hibernation/resume function (in a state shown in FIG. 5), is shifted to a power-on state. It is expected that the generation order of the access request to the main memory 2 in the previous shift to a power-on state and that of the access request to the main memory 2 in this-time shift to a power-on state is substantially the same. Therefore, there is a high probability that an access request to a page saved uncompressed to the NOR flash memory 3.

If the foregoing access request is a read access, the hibernation utility program 150 intactly uses the address on the NOR flash memory 3, which is temporarily recorded in the page table. Then, the utility program 150 takes the procedure of the access request according to the access to the NOR flash memory 3. For example, there is no need to restore data from the NOR flash memory 3 to the main memory 2 in the read access until the application program 200 completes an output of a predetermined application screen. This serves to greatly shorten time until the apparatus becomes a usable state after the power-on operation.

After the application program 200 completes the output screen, if the CPU 1 is in an idle state, the hibernation utility program 150 executes the following operations using the idle period. First, the utility program 150 restores a page, which is compressed to be stored in the NOR flash memory 3 and is not still restored to the main memory 2. Secondary, the utility program 150 restores a page, which is stored uncompressed in the NOR flash memory 3 and is not still restored to the main memory 2, and updates address of the page table (so that address on the inherently main memory 2 is shown).

The foregoing operation is executed, and thereby, for example, the following advantage is expected. Specifically, when the user see a screen output by the application program to start any operation, the page saved (partially compressed) to the NOR flash memory 3 is restored to the main memory 2. Therefore, the NOR flash memory 3 including a capacity smaller than the main memory 2 effectively realizes the hibernation/resume function. It should be noted that the hibernation utility program 150 independently executes restoration of the page to the main memory 2 when the following cases occur. One is the case where a write access request to a page, which is not still restored to the main memory 2 and is saved uncompressed to the NOR flash memory 3, is generated. The other is the case where an access request to a page, which is not still restored to the main memory 2 and is saved compressed to the NOR flash memory 3, is generated.

FIG. 6 is an exemplary flowchart showing an operation procedure of the hibernation utility program 150 when the information processing apparatus, which shifts to a power-off state by the hibernation/resume function, is shifted to a power-on state.

The hibernation utility program 150 reads a page table from the NOR flash memory 3 to restore it on the main memory 2 (block B1). After the page table is restored, if an access request to the main memory 2 is generated (YES in block B2), the utility program 150 checks whether or not the request passes a predetermined point after resume starts, that is, a predetermined notification from the application program 200 is received (block B3). If the notification is not received (NO in block B3), the order of the access request to the page is recorded in the page table (block B4).

If the predetermined notification from the application program 200 is received (YES in block B3), the hibernation utility program 150 does not record the access order in the page table. According to this embodiment, the judgment reference of recording in the page table of the access order is based on reception of the predetermined notification from the application program 200. However, in place of the foregoing judgment reference, for example, it is possible to check whether or not a value of an access order reaches a predetermined value led from the capacity of the main memory 2 and that of the NOR flash memory 3.

Then, the hibernation utility program 150 checks whether or not the access request is made with respect to a page, which is stored compressed in the NOR flash memory 3 (block B5). If the access request is made with respect to a page, which is stored compressed in the NOR flash memory 3 (YES in block B5), the utility program 150 executes restoration of the page to t main memory 2 (block B6). This restoration is performed with expanding.

If the access request is made with respect to a page, which is stored uncompressed in the NOR flash memory 3 (NO in block B5), the hibernation utility program 150 further checks whether or not the access request is a write access request (block B7). If the access request is a write access request (YES in block B7), the hibernation utility program 150 executes restoration of the page to the main memory 2 (block B8). This restoration is performed without expanding, what we call, a copy is made. Moreover, if the access request is a read access request (NO in block B7), the hibernation utility program 150 intactly causes the request to access the saved target, that is, the NOR flash memory 3 (block B9).

If an access request to the main memory 2 is not generated (NO in block B2), the hibernation utility program 150 checks whether or not the CPU 1 is in an idle state (block B10). If the CPU 1 is in an idle state (YES in block B10), the hibernation utility program 150 checks whether or not a page, which is not still restored from the saved target NOR flash memory 3 to the main memory 2, remains (block B11). In this case, the hibernation utility program 150 preferentially searches for the remaining page, which is stored compressed in the NOR flash memory 3. Thereafter, the hibernation utility program 150 searches for the remaining page, which is stored uncompressed in the NOR flash memory 3.

If the remaining page is detected (YES in block B11), the hibernation utility program 150 executes restoration of the page to the main memory (block B12). If all pages are already restored (NO in block B11), the procedure ends.

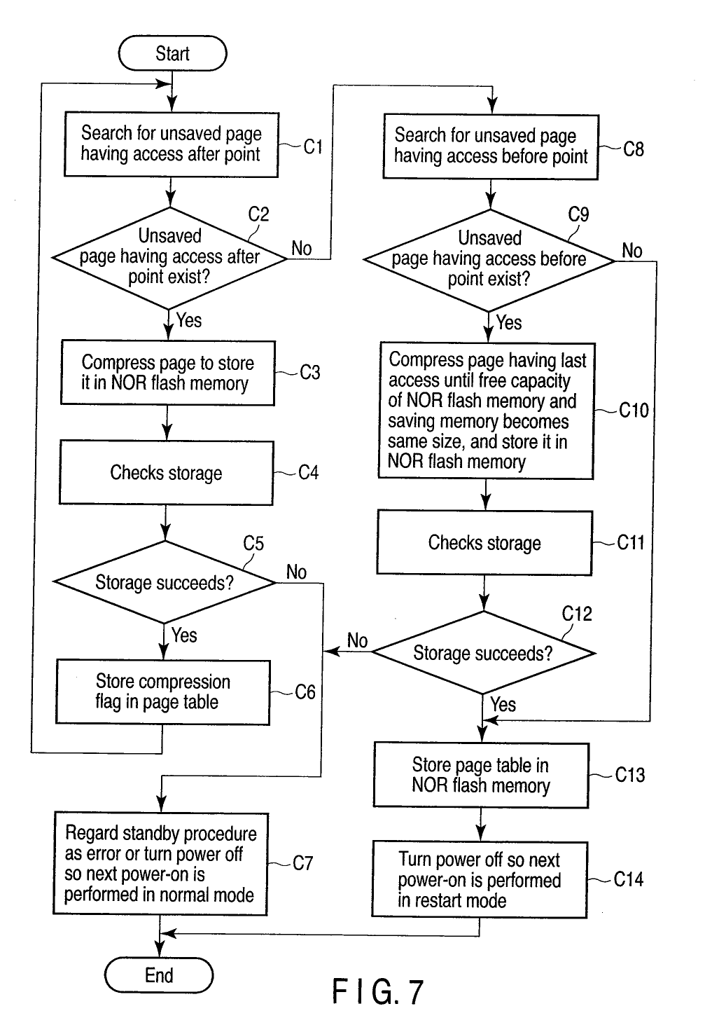

FIG. 7 is an exemplary flowchart showing an operation procedure of the hibernation utility program 150 when the information processing apparatus shifts to a power-off state by the hibernation/resume function after second time.

First, the hibernation utility program 150 checks whether or not a page, which has no access order recording in the page table and is not saved in the NOR flash memory 3, exist (block C1). If the corresponding page exists (YES in block C2), the page is compressed, and then, stored in the NOR flash memory 3 (block C3). The hibernation utility program 150 checks whether or not the foregoing storage to the NOR flash memory 3 is normally completed (block C4). If the storage to the NOR flash memory 3 is normally completed (YES in block C5), the utility program 150 repeats the procedures from block C1.

Conversely, if the storage to the NOR flash memory 3 is not normally completed (NO in block C5), the hibernation utility program 150 takes the following procedure (block C7). Specifically, the utility program 150 ends the shift to a power-off state by the hibernation/resume function as an error. Or, the utility program 150 causes the information processing apparatus to shift to a power-off state so that the next shift to a power-on state is performed via a normal procedure.

Conversely, if there exists no page, which has no access order recording in the page table and is not saved in the NOR flash memory 3 (NO in block C2), the hibernation utility program 150 checks a page, which has access order recording in the page table and is not saved in the NOR flash memory 3, exist(block C8). If the corresponding page exists (YES in block C9), the hibernation utility program 150 takes the following procedure. Specifically, the utility program 150 compresses a page having the last access order, and stores it in the NOR flash memory 3 until the total amount of capacity of the remaining page becomes less than a free capacity of the NOR flash memory 3. If the total amount of capacity becomes less than a free capacity of the NOR flash memory 3, the remaining pages are all stored uncompressed in the NOR flash memory (block C10).

When compressing a page having access order recording in the page table and saving it in the NOR flash memory 3, the hibernation utility program 150 reduces the compression ratio compared with the case of compressing a page having no access order recording in the page table and saving it in the NOR flash memory 3. With respect to the page, the expanding processing time is shortened even if it is few. In addition, it is effective to reduce the compression ratio from the page having the last access order toward the previous page. Namely, the expanding processing time of the page, which is expected to earlier generate an access request in the next shift to a power-on state, is shortened.

Then, the hibernation utility program 150 checks whether or not storage to the NOR flash memory 3 normally ends (block C11). If the storage normally ends (YES in block C12), the utility program 150 stores the page table uncompressed in the NOR flash memory 3 (block C13). Further, the utility program 150 causes the information processing apparatus to shift to a power-off state so that the next shift to a power-on state is performed by the hibernation/resume function (block C14). Conversely, if the storage does not normally end (NO in block C12), the hibernation utility program 150 takes the following procedure (block C7). Specifically, the utility program 150 ends the shift to a power-off state by the hibernation/resume function as an error. Or, the utility program 150 causes the information processing apparatus to shift to a power-off state so that the next shift to a power-on state is performed via a normal procedure.

As seen from the foregoing description, the information processing apparatus effectively realizes a hibernation/resume function using the NOR flash memory 3 having a capacity smaller than the main memory 2.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An information processing apparatus comprising:
a CPU;
a first memory which is a volatile memory and which is assigned a storage area accessible by the CPU;
a second memory which is a non-volatile memory and which includes a capacity smaller than the first memory; and
a hibernation/resume module configured to save data stored in the first memory in the second memory at the time of a shift to a power-off state, and to restore data saved in the second memory to the first memory at the time of a shift to a power-on state,
the hibernation/resume module including:
an access log recording module configured to record an access generation order corresponding to each storage area in the first memory after a shift to a power-on state; and
a memory management module configured to save data corresponding to a storage area in which an order in a predetermined range is recorded by the access log recording module in the second memory without compression, and to save data corresponding to other storage areas to save them in the second memory with compression, in a shift to a power-off state.

2. The information processing apparatus of claim 1, wherein:
the access log recording module stops recording of the access generation order when receiving a predetermined notification from a program executed by the CPU, and
the memory management module saves data corresponding to a storage area in which the access generation order is recorded by the access log recording module in the second memory without compression, and saves data corresponding to other storage areas in the second memory with compression.

3. The information processing apparatus of claim I wherein:
the access log recording module records the access generation order until a value of the access generation order reaches a predetermined value, and
the memory management module saves data corresponding to a storage area in which the access generation order is recorded by the access log recording module in the second memory without compression, and saves data corresponding to other storage areas in the second memory with compression.

4. The information processing apparatus of claim 1, wherein the memory management module selects, after saving data corresponding to the other storage areas in the second memory with compression, data corresponding to a storage area in which an order within a predetermined range is recorded in the order of descending, and compresses and saves the selected data in the second memory, until the total amount of data corresponding to a storage area in which the order within a predetermined range is recorded and which is not saved to the second memory becomes less than a free capacity of the second memory.

5. The information processing apparatus of claim 4, wherein the memory management module performs compression at a compression ratio lower than the case of compressing data corresponding to the other storage areas and saving the data in the second memory, when the memory management module saves data corresponding to a storage area in which the order within a predetermined range in the second memory with compression.

6. The information processing apparatus of claim 5, wherein the memory management module compresses data corresponding to a storage area having the last order with a higher compression ratio when the memory management module saves data corresponding to a storage area in which the order within a predetermined range in the second memory with compression.

7. The information processing apparatus of claim 1 wherein the memory management module reads, when access is generated with respect to a storage area of the first memory in which data saved in the second memory is not restored, data saved in the second memory without restoration to the first memory if the data is saved without compression and the access is data read in the storage area after the apparatus shifts to a power-on state.

8. The information processing apparatus of claim 1 wherein the memory management module restores data saved in the second memory, which is not restored to the first memory, to the first memory if the CPU is in an idle state after the apparatus shifts to a power-on state.

9. The information processing apparatus of claim 8, wherein the memory management module preferentially restores data saved with compression rather than data saved without compression when the CPU is in an idle state.

10. A memory management method of an information processing apparatus including a CPU, a first memory which is a volatile memory and which is assigned a storage area accessible by the CPU, a second memory which is a non-volatile memory and which includes a capacity smaller than the first memory, and a hibernation/resume module configured to save data stored in the first memory in the second memory at the time of a shift to a power-off state, and to restore data saved in the second memory to the first memory at the time of a shift to a power-on state, the method comprising:
recording an access generation order corresponding to each storage area in the first memory after the apparatus is shifted to a power-on state by the hibernation/resume module; and saving data corresponding to a storage area in which an order within a predetermined range is recorded the second memory without compression, and saving data corresponding to other storage areas in the second memory with compression, when the apparatus is being shifted to a power-off state by the hibernation/resume module.

11. The memory management method of claim 10, further comprising reading, when access is generated with respect to a storage area on the first memory in which data saved in the second memory is not restored, data saved in the second memory without restoration to the first memory if the data is saved without compression and the access is data read in the storage area, after the apparatus shifts to a power-on state by the hibernation/resume module.

12. The memory management method of claim 10, further comprising restoring data saved in the second memory, which is not restored to the first memory. to the first memory if the CPU is in an idle state after the apparatus is shifted to a power-on state by the hibernation/resume module.
